(19) United States
(12) Patent Application Publication
(10) Pub. No.: US 2017/0277340 A1
(43) Pub. Date: Sep. 28, 2017

(54) TERMINAL CONTROL METHOD AND TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Yan Yu, Beijing (CN)

(21) Appl. No.: 15/361,831

(22) Filed: Nov. 28, 2016

Related U.S. Application Data
(63) Continuation of application No. PCT/CN2016/098200, filed on Sep. 6, 2016.

(30) Foreign Application Priority Data
Mar. 25, 2016 (CN) 2016101803092

(51) Int. Cl. G06F 3/041; G06F 3/033

(52) U.S. Cl. CPC G06F 3/0416; G06F 3/033

(57) ABSTRACT

Embodiments of the present application provide a terminal control method and a terminal thereof. In the embodiments of the present application, an operation of a user on a rear touch panel of a terminal is detected, and then a mouse pointer displayed on a screen of the terminal is controlled according to the operation of the user on the rear touch panel of the terminal. Therefore, according to the embodiments of the present application, the operation manner of controlling the terminal in the related art is changed, to solve the problem that the terminal may not be controlled with a single hand in the related art, simplifies the steps of controlling the terminal by the user, and improves the operation efficiency.

### CROSS-REFERENCE TO RELATED APPLICATIONS

This application is a continuation of International Application No. PCT/CN2016/098200 with an international filing date of Sep. 6, 2016, which is based upon and claims priority to Chinese Patent Application No. CN201610180309.2, filed on Mar. 25, 2016, the entire contents of all of which are incorporated herein by reference.

### TECHNICAL FIELD

The present application relates to the technical field of communications, and more particularly, to a terminal control method and a terminal thereof.

### BACKGROUND

At present, the screens of terminals are becoming larger and larger. During use of the terminal, a user would find it hard to hold the terminal with one hand, and meanwhile tap the screen of the terminal with this hand to control the terminal.

During the implementation of the present application, the inventors have identified that the related art has at least the following problem:

In the related art, with the increase of the size of the screen of the terminal, the user generally needs to use two hands collaboratively to control the terminal, but hard to operate the terminal with only one hand. Thus, the operation efficiency is low. However, in the related art, no method is available to control the terminal with a single hand simply.

### SUMMARY

In view of the above, embodiments of the present application provides a terminal control method and a terminal thereof, to solve the problem that the terminal may not be controlled simply by using a single hand in the related art.

To achieve the objective of the present application, in one aspect, embodiments of the present application provide a terminal control method. The method includes:

detecting an operation of a user on a rear touch panel of a terminal; and

controlling, according to the operation of the user on the rear touch panel of the terminal, a mouse pointer displayed on a screen of the terminal.

According to the above aspect and any one possible implementation manner, another implementation manner is further provided, wherein prior to the detecting an operation of a user on a rear touch panel of a terminal, the method further includes:

detecting an operation of the user on the terminal;

enabling the rear touch panel of the terminal if the operation of the user on the terminal is consistent with a designated enable operation; and

displaying the mouse pointer on the screen of the terminal.

According to the above aspect and any one possible implementation manner, another implementation manner is further provided, wherein the method further includes:

disabling the rear touch panel if it is detected that the user performs no operation on the rear touch panel within a designated period of time; or

detecting an operation of the user on the terminal, and disabling the rear touch panel if it is detected that the operation of the user on the terminal is consistent with a designated disable operation.

According to the above aspect and any one possible implementation manner, another implementation manner is further provided, wherein in the process of controlling the mouse pointer displayed on the screen of the terminal, the position of the mouse pointer on the screen of the terminal corresponds to the position on the finger of the user on the rear touch panel; and/or the operation of the mouse pointer on the screen of the terminal corresponds to the operation of the user on the rear touch panel.

According to the above aspect and any one possible implementation manner, another implementation manner is further provided, wherein the detecting an operation of a user on a rear touch panel of a terminal includes: detecting, by a drive corresponding to the rear touch panel in the terminal, the operation of the user on the rear touch panel, and generating operation information; and

the controlling, according to the operation of the user on the rear touch panel of the terminal, a mouse pointer displayed on a screen of the terminal includes: acquiring, by a hardware abstraction layer in the terminal, an event corresponding to the operation information according to the operation information sent by the drive corresponding to the rear touch panel; and sending, by an framework layer in the terminal, the event acquired by the hardware abstraction layer to an operating system of the terminal, such that the operating system controls, according to the event, the mouse pointer displayed on the screen of the terminal.

To achieve the above objective of the present application, in another aspect, embodiments of the present application further provide a terminal, including: at least one memory and one or more processors, wherein the one or more processors are configured to execute program instructions stored in the at least one memory to:

detect an operation of a user on a rear touch panel of the terminal; and

control, according to the operation of the user on the rear touch panel of the terminal, a mouse pointer displayed on a screen of the terminal.

According to the above aspect and any one possible implementation manner, another implementation manner is further provided, wherein prior to the detecting an operation of a user on a rear touch panel of a terminal, the one or more processors are further configured to execute the program instructions stored in the at least one memory to:

detect an operation of the user on the terminal;

enable the rear touch panel of the terminal if the operation of the user on the terminal is consistent with a designated enable operation; and

display the mouse pointer on the screen of the terminal.

According to the above aspect and any one possible implementation manner, another implementation manner is further provided, wherein the one or more processors are configured to execute program instructions stored in the at least one memory to: disable the rear touch panel if it is detected that the user performs no operation on the rear touch panel within a designated period of time; or

detect an operation of the user on the terminal, and disable the rear touch panel if it is detected that the operation of the user on the terminal is consistent with a designated disable operation.

According to the above aspect and any one possible implementation manner, another implementation manner is further provided, wherein the one or more processors are further configured to execute the program instructions stored in the at least one memory to: in the process of controlling the mouse pointer displayed on the screen of the terminal, cause the position of the mouse pointer on the screen of the terminal to correspond to the position on the finger of the user on the rear touch panel; and/or cause the operation of the mouse pointer on the screen of the terminal to correspond to the operation of the user on the rear touch panel.

According to the above aspect and any one possible implementation manner, another implementation manner is further provided, wherein the detecting an operation of a user on a rear touch panel of a terminal includes: detecting, by a drive corresponding to the rear touch panel in the terminal, the operation of the user on the rear touch panel, and generating operation information;

the controlling, according to the operation of the user on the rear touch panel of the terminal, a mouse pointer displayed on a screen of the terminal includes: acquiring, by a hardware abstraction layer in the terminal, an event corresponding to the operation information according to the operation information sent by the drive corresponding to the rear touch panel; and sending, by an framework layer in the terminal, the event acquired by the hardware abstraction layer to an operating system of the terminal, such that the operating system controls, according to the event, the mouse pointer displayed on the screen of the terminal; and

sending, by an framework layer in the terminal, the event acquired by the hardware abstraction layer to an operating system of the terminal, such that the operating system controls, according to the event, the mouse pointer displayed on the screen of the terminal

A non-transitory computer readable storage medium storing computer readable instructions is further provided, wherein the computer readable instructions are configured to:

detect an operation of a user on a rear touch panel of a terminal; and

control, according to the operation of the user on the rear touch panel of the terminal, a mouse pointer displayed on a screen of the terminal.

According to the above aspect and any one possible implementation manner, another implementation manner is further provided, wherein prior to the detecting an operation of a user on a rear touch panel of a terminal, the computer readable instructions are further configured to:

detect an operation of the user on the terminal;

enable the rear touch panel of the terminal if the operation of the user on the terminal is consistent with a designated enable operation; and

display the mouse pointer on the screen of the terminal.

According to the above aspect and any one possible implementation manner, another implementation manner is further provided, wherein the computer readable instructions are further configured to:

disable the rear touch panel if it is detected that the user performs no operation on the rear touch panel within a designated period of time; or

detect an operation of the user on the terminal, and disable the rear touch panel if it is detected that the operation of the user on the terminal is consistent with a designated disable operation.

According to the above aspect and any one possible implementation manner, another implementation manner is further provided, wherein the computer readable instructions are further configured to: in the process of controlling the mouse pointer displayed on the screen of the terminal, cause the position of the mouse pointer on the screen of the terminal to correspond to the position on the finger of the user on the rear touch panel; and/or cause the operation of the mouse pointer on the screen of the terminal to correspond to the operation of the user on the rear touch panel.

According to the above aspect and any one possible implementation manner, another implementation manner is further provided, wherein:

the detecting an operation of a user on a rear touch panel of a terminal includes: detecting, by a drive corresponding to the rear touch panel in the terminal, the operation of the user on the rear touch panel, and generating operation information; and

the controlling, according to the operation of the user on the rear touch panel of the terminal, a mouse pointer displayed on a screen of the terminal includes: acquiring, by a hardware abstraction layer in the terminal, an event corresponding to the operation information according to the operation information sent by the drive corresponding to the rear touch panel; and sending, by an framework layer in the terminal, the event acquired by the hardware abstraction layer to an operating system of the terminal, such that the operating system controls, according to the event, the mouse pointer displayed on the screen of the terminal; and

sending, by an framework layer in the terminal, the event acquired by the hardware abstraction layer to an operating system of the terminal, such that the operating system controls, according to the event, the mouse pointer displayed on the screen of the terminal

As compared with the related art, the above technical solutions achieve the following beneficial effects:

In the embodiments of the present application, an operation of a user on a rear touch panel of a terminal is detected, and then a mouse pointer displayed on a screen of the terminal is controlled according to the operation of the user on the rear touch panel of the terminal. According to the embodiments of the present application, the rear touch panel is arranged on the back of the terminal, such that when the user holds the terminal with a single hand, the user is capable of simply controlling the terminal by means of performing an operation on the rear touch panel of the terminal with a finger, with no need of assistance by the other hand. Therefore, according to the embodiments of the present application, the operation manner of controlling the terminal in the related art is changed, which solves the problem that the terminal may not be controlled with a single hand in the related art, simplifies the steps of controlling the terminal by the user, and improves the operation efficiency.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating a terminal control method according to a first embodiment of the present application;

FIG. 2 is a schematic flowchart illustrating content displayed on a screen of a terminal in the terminal control method according to the first embodiment of the present application;

FIG. 3 is an implementation framework diagram illustrating the terminal control method according to the first embodiment of the present application; and

FIG. 4 is a schematic structural diagram illustrating hardware of the terminal according to the second embodiment of the present application.

### DETAILED DESCRIPTION

For better understanding of the technical solutions of the present application, detailed description is given hereinafter to embodiments of the present application with reference to the accompanying drawings.

It should be noted that, the embodiments described herein are merely exemplary ones, but are not all the embodiments of the present application. Based on the embodiments of the present application, all other embodiments derived by persons of ordinary skill in the art without any creative efforts shall fall within the protection scope of the present application.

The terminology used in the embodiments of the present application is for the purpose of describing particular embodiments only and is not intended to limit the present application. As used in the embodiments of the present application and the appended claims, the singular forms “a”, “an” and “the” are intended to include the plural forms as well, unless the context clearly indicates otherwise.

It should be understood that the term “and/or” used herein is merely an association relationship for describing associated objects, which represents that there may exist three types of relationships, for example, A and/or B may represent three situations: only A exists, both A and B exist, and only B exists. In addition, the character “/” herein generally represents an “or” relationship between associated objects before and after the character.

As used herein, the term “if” may be understood to mean “when” or “upon” or “in response to determining” or “in response to detecting” depending on the context. Similarly, depending on the context, the phrases “if it is determined” or “if it is detected (stating a condition or a fact) may be interpreted as “when it is determined” or “in response to determining (stating a condition or a fact)” or “in response to detecting (stating a condition or a fact)”.

### First Embodiment

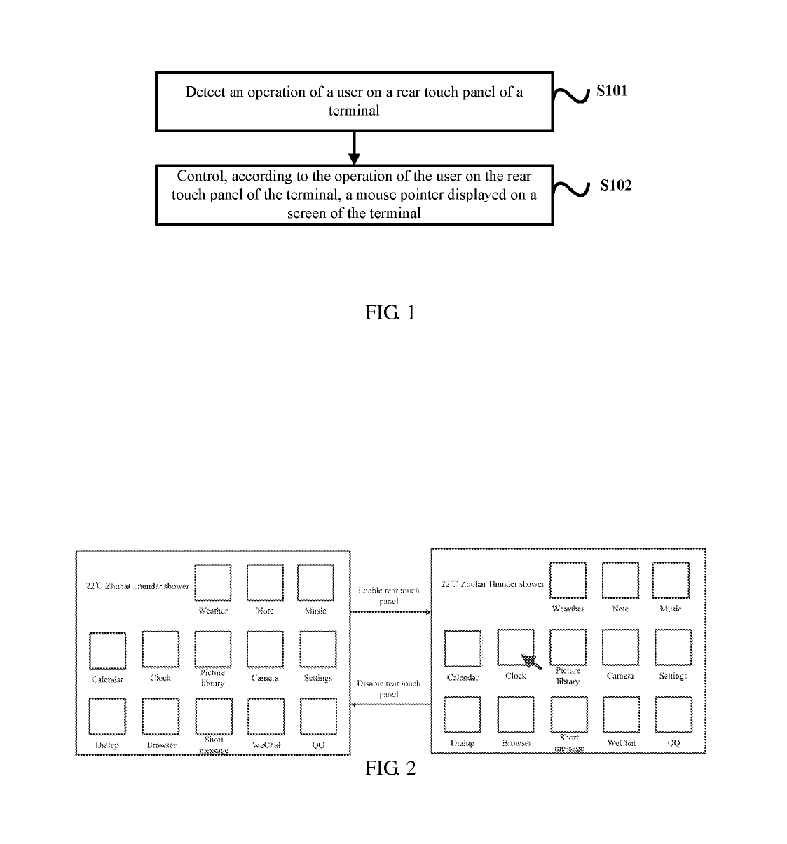

This embodiment of the present application provides a terminal control method. Referring to FIG. 1, a schematic diagram illustrating a terminal control method according to this embodiment of the present application is given. As illustrated in FIG. 1, the method includes the following steps:

S101: An operation of a user on a rear touch panel of a terminal is detected.

Specifically, the operation of the user on the rear touch panel of the terminal according to this embodiment of the present application is to control a mouse pointer displayed on a screen of the terminal.

It should be noted that the terminal involved in the embodiment of the present application may include, but not limited to, a person computer (PC), a personal digital assistant (PDA), a wireless handheld device, a mobile phone, an MP3 player, an MP4 player and the like.

It may be understood that the rear touch panel arranged on the back of the terminal provides touch control input, and the mouse pointer displayed on the screen of the terminal is controlled by means of tracking a tap, swipe or press operation of a finger on the rear touch panel of the terminal.

In this embodiment of the present application, the size of the rear touch panel of the terminal may be the equal to or different from the size of the screen of the terminal. For example, a 10-cm elongated operation region may be arranged on the back of the terminal as the rear touch panel.

In this embodiment of the present application, the rear touch panel of the terminal may be implemented by using a virtual key, a sensor or a screen.

For example, the rear touch panel of the terminal may be implemented by the screen. Hereinafter, description is given by using a capacitive touch screen as an example. When the finger of the user touches the rear touch panel, the capacitance at the touch point is subject to changes, such that the frequency of an oscillator connected to a capacitor is subject to changes. The touch position may be determined by measuring changes of the frequency of the oscillator, and hence operation information of the user on the rear touch panel of the terminal may be acquired.

Alternatively, for example, the rear touch panel of the terminal may be implemented by a virtual key. If the rear touch panel of the terminal is provided with a virtual key having specific functions. Description is given hereinafter by using a capacitive virtual key as an example. When the user presses the virtual key, the terminal may judge, according to the capacitance of the capacitive virtual key, which virtual key the user operates. Specifically, when the user touches the capacitive virtual key, the finger of the user may form a capacitor with an electrode of the capacitive virtual key, and the terminal determines, by detecting changes of the capacitance, the position which the user touches to determine which virtual key the user touches, such that operation information of the user on an edge touch control region of the terminal may be acquired.

Alternatively, for example, the rear touch panel of the terminal may be implemented by a sensor. If the rear touch panel of the terminal is provided with a sensor having specific functions, description is given hereinafter by using a pressure sensor as an example. When the user presses the pressure sensor, a semiconductor deformation pressure is formed on the surface of a thin sheet of the pressure sensor, and the thin sheet is pressed to achieve a piezoelectric impedance effect, such that the impedance is converted into an electric signal. Upon acquiring the electric signal, the terminal may determine which pressure sensor the user presses, or which position on the pressure sensor the user touches, such that it is determined which function of the pressure sensor the user touches, and thus the operation of the user on the rear touch panel of the terminal may be acquired. Further, the sensor having specific functions arranged on the rear touch panel the terminal may also be an optical sensor.

In this embodiment of the present application, the rear touch panel of the terminal may be enabled or disabled according to user's needs.

In this embodiment of the present application, prior to detecting the operation of the user on the rear touch panel of the terminal, the rear touch panel of the terminal needs to be enabled. The method for enabling the rear touch panel includes: detecting an operation of the user on the terminal, enabling the rear touch panel of the terminal if the operation of the user on the terminal is consistent with a designated enable operation, and displaying the mouse pointer on the screen of the terminal.

Specifically, the user may predefine a designated enable operation according to actual needs, wherein the designated enable operation may include: operations performed on the screen, the rear touch panel, the edge touch control panel, the virtual key, the physical key and the like of the terminal. For example, the user may predefine a double-tap operation on the screen of the terminal as the designated enable operation; or the user may predefine an upward swipe operation on the edge touch control region of the terminal as the designated enable operation; or the user may predefine a downward swipe operation on the rear touch control panel of the terminal as the designated enable operation; or the user may predefine a press operation on a physical key of the terminal as the designated enable operation; or the user may predefine a press operation on a virtual key of the terminal as the designated enable operation.

Specifically, the terminal acquires the operation of the user on the terminal, and enables the rear touch panel of the terminal as long as the operation of the user on the terminal is consistent with the designated enable operation. After the rear touch panel of the terminal is enabled, the terminal may display the mouse pointer on the screen of the terminal.

Referring to FIG. 2, a schematic diagram illustrating a schematic flowchart of content displayed on a screen of a terminal in the terminal control method according to a first embodiment of the present application is given. As illustrated in FIG. 2, after the rear touch panel of the terminal is enabled, the terminal may display a mouse pointer on the screen of the terminal. Specifically, the mouse point is displayed in a default display mode of the terminal system, and the user may also define another display mode.

In this embodiment of the present application, the rear touch panel of the terminal may also be disabled in the following two manners:

First Manner:

If it is detected that a user performs no operation on the rear touch panel within a designated period of time, the rear touch panel is disabled.

The user may perform an operation on the enabled rear touch panel, and the terminal may operation on the rear touch panel to generate operation information. If the terminal does not detect the operation information generated by performing an operation on the rear touch panel by the user within the designated period of time, the terminal automatically disables the rear touch panel. After the rear touch panel of the terminal is disabled, the mouse pointer displayed on the screen of the terminal disappears on the screen of the terminal, and the state before the rear touch panel is enabled is resumed.

Specifically, the designated period of time when the terminal automatically disables the rear touch panel may be predefined according to user's needs. For example, the user may predefine the designated period of time may be 30 s, and if the terminal detects within 30 s that the user performs no operation on the rear touch panel, the terminal automatically disables the rear touch panel.

Specifically, the user may also select, according to the actual needs, whether to enable the function of automatically disabling the rear touch panel. If the mobile terminal enables the function, the rear touch panel of the terminal may be automatically disabled by using the method for detecting the operation information of the user on the rear touch panel. If the terminal does not enable the function, the terminal detects the operation of the user on the rear touch panel, and even if the terminal detects the operation information of the user within the designated period of time, the operation of disabling the rear touch panel is not performed and the enabling state of the rear touch panel is maintained.

Second Manner:

If it is detected that the operation of the user on the terminal is consistent with a designated disable operation, the rear touch panel is disabled.

Specifically, the user may predefine a designated disable operation according to actual needs, wherein the designated disable operation may include: operations performed on the screen, the rear touch panel, the edge touch control panel, the virtual key, the physical key and the like of the terminal. For example, the user may predefine a double-tap operation on the screen of the terminal as the designated disable operation; or the user may predefine an upward swipe operation on the edge touch control region of the terminal as the designated disable operation; or the user may predefine a downward swipe operation on the rear touch control panel of the terminal as the designated disable operation; or the user may predefine a press operation on a physical key of the terminal as the designated disable operation; or the user may predefine a press operation on a virtual key of the terminal as the designated disable operation.

Specifically, the terminal acquires the operation of the user on the terminal, and disables the rear touch panel of the terminal as long as the operation of the user on the terminal is consistent with the designated disable operation. After the rear touch panel of the terminal is disabled, the mouse pointer displayed on a front screen of the terminal disappears on the front screen.

Referring to FIG. 2, a schematic diagram illustrating a schematic flowchart of content displayed on a screen of a terminal in the terminal control method according to the first embodiment of the present application is given. As illustrated in FIG. 2, after the rear touch panel of the terminal is disabled, the mouse pointer displayed on the screen of the terminal disappears on the screen, and the state before the rear touch panel is enabled is resumed.

S102: A mouse pointer displayed on a screen of the terminal is controlled a according to the operation of the user on the rear touch panel of the terminal.

Specifically, the mouse pointer displayed on the screen of the terminal by means of a simple operation of the user on the rear touch panel of the terminal, such that the terminal is controlled.

In this embodiment of the present application, in the process of controlling the mouse pointer displayed on the screen of the terminal, the position of the mouse pointer on the screen of the terminal corresponds to the position on the finger of the user on the rear touch panel; and/or the operation of the mouse pointer on the screen of the terminal corresponds to the operation of the user on the rear touch panel.

Specifically, if the size of the screen of the terminal is equal to the size of the rear touch panel of the terminal, the position of the mouse pointer on the screen of the terminal one-to-one corresponds to the position of the finger of the user on the rear touch panel; and/or the operation of the mouse pointer on the screen of the terminal one-to-one corresponds to the operation of the user on the rear touch panel.

Specifically, if the size of the screen of the terminal is equal to the size of the rear touch panel of the terminal, the position of the mouse pointer on the screen of the terminal corresponds to the position of the finger of the user on the rear touch panel according to a specific proportion or rule; and/or the operation of the mouse pointer on the screen of the terminal corresponds to the operation of the user on the rear touch panel according to a specific proportion or rule.

For example, if the proportion of the size of the screen of the terminal to the size of the rear touch panel of the terminal is 1:10, the position of the mouse pointer on the screen of the terminal corresponds to the position of the finger of the user on the rear touch panel scaled up according to the proportion of 1:10. Therefore, the operation of the mouse pointer on the screen of the terminal also corresponds to the operation of the user on the rear touch panel. It may be understood that the sizes of the screen of the terminal and the rear touch panel of the terminal and the corresponding rule thereof are determined according to the practical implementation.

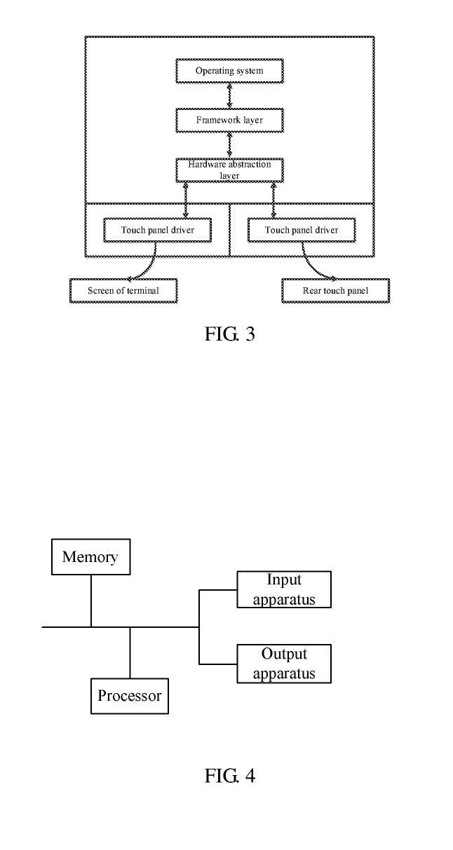

Referring to FIG. 3, an implementation framework diagram illustrating the terminal control method according to the first embodiment of the present application is given. As illustrated in FIG. 3, a software framework of the terminal may include: an operating system, a framework layer and a hardware abstraction layer (HAL); and a hardware framework of the terminal may include: two touch panel drivers, and a screen and rear touch panel of the terminal.

It may be understood that the terminal is provided with two touch panel drivers, which respectively correspond to the screen of the terminal and the rear touch panel of the terminal. That is, operation information of the user on the screen of the terminal is detected and acquired by a touch panel driver corresponding to the screen of the terminal, and operation information of the user on the rear touch panel is detected and acquired by a touch panel driver corresponding to the rear touch panel.

After the rear touch panel of the terminal is enabled, the touch panel driver corresponding to the rear touch panel in the terminal detects the operation of the user on the rear touch panel of the terminal, and generates the operation information. Afterwards, the touch panel driver corresponding to the rear touch panel reports the acquired operation information to the hardware abstraction layer of the terminal.

The hardware abstraction layer of the terminal is a software and hardware adaptation layer in the terminal, and performs data interactions with the two touch panel drivers of the terminal. The hardware abstraction layer of the terminal performs software and hardware adaptation to the operation information sent by the touch panel driver corresponding to the rear touch panel, and acquires an event corresponding to the received operation. The framework layer of the terminal sends the event acquired by the hardware abstraction layer to the operating system of the terminal, such that the operating system controls the mouse pointer displayed on the screen of the terminal according to the received event, thereby controlling the terminal.

Therefore, in this embodiment of the present application, the conventional software framework of the terminal and hardware framework of the screen of the terminal are not changed. Instead, the rear touch panel and the touch panel driver corresponding to the rear touch panel are only added to the terminal. Interactions of the two touch panel drivers with the hardware abstraction layer are the same. The software framework layer of the terminal processes information according to the original processing mechanism. The screen and rear touch panel of the terminal are respectively controlled by the corresponding drivers. The operation of the user on the rear touch panel and the operation of the user on the screen of the terminal are performed independently of each other. Therefore, the framework and implementation are simplified, and the system resources are saved.

The technical solution according to this embodiment of the present application has the following beneficial effects:

In this embodiment of the present application, an operation of a user on a rear touch panel of a terminal is detected, and then a mouse pointer displayed on a screen of the terminal is controlled according to the operation of the user on the rear touch panel of the terminal. According to this embodiment of the present application, the rear touch panel is arranged on the back of the terminal, such that when the user holds the terminal with a single hand, the user is capable of simply controlling the terminal by means of performing an operation on the rear touch panel of the terminal with a finger, with no need of assistance by the other hand. Therefore, according to this embodiment of the present application, the operation manner of controlling the terminal in the related art is changed, which solves the problem that the terminal may not be controlled with a single hand in the related art, simplifies the steps of controlling the terminal by the user, simplifies the framework and implementation, saves the system resources, and improves the operation efficiency.

### Second Embodiment

Based on the terminal control method according to the first embodiment, this embodiment of the present application further provides a terminal which performs the steps and method according to the above method embodiment.

Referring to FIG. 4, a schematic structural diagram illustrating hardware of the terminal according to the second embodiment of the present application is given. The terminal includes one or more processors and a memory. Description is given herein by using one processor as an example. The terminal may further include an input apparatus and an output apparatus.

The processor, the memory, the input apparatus and the output apparatus may be connected to each other via a bus or in another manner. FIG. 4 uses connection via a bus as an example for description.

The memory, as a non-transitory computer readable storage medium, may be used to store non-transitory software programs, and non-transitory computer executable programs and modules. The non-transitory software programs, instructions and modules stored in the memory, when being executed, cause the processor to perform various function applications and data processing of an electronic device, that is, performing the methods according to the above method embodiments.

The memory may also include a program storage area and a data storage area. The program storage area may store an operating system and an application implementing at least one function. The data storage area may store data and the like. In addition, the memory may include a high speed random access memory, or include a non-transitory memory, for example, at least one disk storage device, a flash memory device, or another non-transitory solid storage device. In some embodiments, the memory optionally includes memories remotely configured relative to the processor. These memories may be connected to the processor over a network. The above examples include, but not limited to, the Internet, Intranet, local area network, mobile communication network and a combination thereof.

The input apparatus may receive may receive input digital or character information, and generate signal input, including a rear touch panel. The output apparatus may include a display screen or the like display device.

The one or more processors are configured to execute the program instructions stored in the at least one memory to:

detect an operation of a user on a rear touch panel of the terminal; and

control, according to the operation of the user on the rear touch panel of the terminal, a mouse pointer displayed on a screen of the terminal.

Prior to the detecting an operation of a user on a rear touch panel of a terminal, the one or more processors are further configured to execute the program instructions stored in the at least one memory to:

detect an operation of the user on the terminal;

enable the rear touch panel of the terminal if the operation of the user on the terminal is consistent with a designated enable operation; and

display the mouse pointer on the screen of the terminal.

The one or more processors are further configured to execute the program instructions stored in the at least one memory to: disable the rear touch panel if it is detected that the user performs no operation on the rear touch panel within a designated period of time; or

detect an operation of the user on the terminal, and disable the rear touch panel if it is detected that the operation of the user on the terminal is consistent with a designated disable operation.

The one or more processors are further configured to execute the program instructions stored in the at least one memory to: in the process of controlling the mouse pointer displayed on the screen of the terminal, cause the position of the mouse pointer on the screen of the terminal to correspond to the position on the finger of the user on the rear touch panel; and/or cause the operation of the mouse pointer on the screen of the terminal to correspond to the operation of the user on the rear touch panel.

The detecting an operation of a user on a rear touch panel of a terminal includes: detecting, by a drive corresponding to the rear touch panel in the terminal, the operation of the user on the rear touch panel, and generating operation information; and

the controlling, according to the operation of the user on the rear touch panel of the terminal, a mouse pointer displayed on a screen of the terminal includes: acquiring, by a hardware abstraction layer in the terminal, an event corresponding to the operation information according to the operation information sent by the drive corresponding to the rear touch panel; and sending, by an framework layer in the terminal, the event acquired by the hardware abstraction layer to an operating system of the terminal, such that the operating system controls, according to the event, the mouse pointer displayed on the screen of the terminal; and

sending, by an framework layer in the terminal, the event acquired by the hardware abstraction layer to an operating system of the terminal, such that the operating system controls, according to the event, the mouse pointer displayed on the screen of the terminal

The technical solution according to this embodiment of the present application has the following beneficial effects:

In this embodiment of the present application, an operation of a user on a rear touch panel of a terminal is detected, and then a mouse pointer displayed on a screen of the terminal is controlled according to the operation of the user on the rear touch panel of the terminal. According to this embodiment of the present application, the rear touch panel is arranged on the back of the terminal, such that when the user holds the terminal with a single hand, the user is capable of simply controlling the terminal by means of performing an operation on the rear touch panel of the terminal with a finger, with no need of assistance by the other hand. Therefore, according to this embodiment of the present application, the operation manner of controlling the terminal in the related art is changed, which solves the problem that the terminal may not be controlled with a single hand in the related art, simplifies the steps of controlling the terminal by the user, simplifies the framework and implementation, saves the system resources, and improves the operation efficiency.

### Third Embodiment

Based on the terminal control method according to the first embodiment, this embodiment of the present application further provides a non-transitory computer readable storage medium which performs the steps and method according to the above method embodiment.

The non-transitory computer readable storage medium stores computer readable instructions, wherein the computer readable instructions are configured to:

detect an operation of a user on a rear touch panel of a terminal; and

control, according to the operation of the user on the rear touch panel of the terminal, a mouse pointer displayed on a screen of the terminal.

Prior to the detecting an operation of a user on a rear touch panel of a terminal, the computer readable instructions are further configured to:

detect an operation of the user on the terminal;

enable the rear touch panel of the terminal if the operation of the user on the terminal is consistent with a designated enable operation; and

display the mouse pointer on the screen of the terminal.

The computer readable instructions are further configured to: disable the rear touch panel if it is detected that the user performs no operation on the rear touch panel within a designated period of time; or

detect an operation of the user on the terminal, and disable the rear touch panel if it is detected that the operation of the user on the terminal is consistent with a designated disable operation.

The computer readable instructions are further configured to: in the process of controlling the mouse pointer displayed on the screen of the terminal, cause the position of the mouse pointer on the screen of the terminal to correspond to the position on the finger of the user on the rear touch panel; and/or cause the operation of the mouse pointer on the screen of the terminal to correspond to the operation of the user on the rear touch panel.

The detecting an operation of a user on a rear touch panel of a terminal includes: detecting, by a drive corresponding to the rear touch panel in the terminal, the operation of the user on the rear touch panel, and generating operation information; and

the controlling, according to the operation of the user on the rear touch panel of the terminal, a mouse pointer displayed on a screen of the terminal includes: acquiring, by a hardware abstraction layer in the terminal, an event corresponding to the operation information according to the operation information sent by the drive corresponding to the rear touch panel; and sending, by an framework layer in the terminal, the event acquired by the hardware abstraction layer to an operating system of the terminal, such that the operating system controls, according to the event, the mouse pointer displayed on the screen of the terminal; and

sending, by an framework layer in the terminal, the event acquired by the hardware abstraction layer to an operating system of the terminal, such that the operating system controls, according to the event, the mouse pointer displayed on the screen of the terminal

The technical solution according to this embodiment of the present application has the following beneficial effects:

In this embodiment of the present application, an operation of a user on a rear touch panel of a terminal is detected, and then a mouse pointer displayed on a screen of the terminal is controlled according to the operation of the user on the rear touch panel of the terminal. According to this embodiment of the present application, the rear touch panel is arranged on the back of the terminal, such that when the user holds the terminal with a single hand, the user is capable of simply controlling the terminal by means of performing an operation on the rear touch panel of the terminal with a finger, with no need of assistance by the other hand. Therefore, according to this embodiment of the present application, the operation manner of controlling the terminal in the related art is changed, which solves the problem that the terminal may not be controlled with a single hand in the related art, simplifies the steps of controlling the terminal by the user, simplifies the framework and implementation, saves the system resources, and improves the operation efficiency.

A person skilled in the art would clearly acknowledge that for ease and brevity of description, the specific operation processes of the above described systems, apparatuses and units may be referenced to the relevant portions in the above described method embodiments, which are thus not described herein any further.

In several embodiments provided in the present application, it should be understood that the disclosed system, apparatus and method may be implemented in other manners. The above described device embodiments are merely illustrative. For example, the unit division is merely logical function division and may be other divisions in actual practice. For example, multiple units or components may be combined or integrated into another device, or some features can be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units which are described as separate components may be physically separated or may be not physically separated, and the components which are illustrated as units may be or may not be physical units, that is, the components may be located in the same position or may be distributed into a plurality of network units. Some of or all of the units may be selected according to actual needs to achieve the objectives of the solutions of the embodiments.

In addition, functional units in the embodiments of the present invention may be integrated into one processing unit, or each of the units may exist along physically, or two or more units may be integrated into one unit. The above integrated unit may be practiced in the form of hardware, and may also be practiced in the form of hardware plus a software functional unit.

The integrated unit practiced in the form of software function unit may be stored in a computer-readable storage medium. The software functional unit is stored in a storage medium, including several instructions, when being executed, cause a computer device (which may be a personal computer, a server, a network device or the like) or a processor to perform a part of the steps of the methods in various embodiments of the present application. The storage medium includes various media capable of storing program code, for example, a USB flash disk, a removable hard disk, a read-only memory (ROM), a random access memory (RAM), a magnetic disk, or an optical disc or the like.

The foregoing descriptions are merely preferred embodiments of the present application and are not used to limit the present invention. Any modifications, equivalent replacements, and improvements made without departing from the spirit and principle of the present application shall fall within the protection scope of the present application.

What is claimed is:

1. A terminal control method, comprising:
detecting an operation of a user on a rear touch panel of a terminal; and
controlling, according to the operation of the user on the rear touch panel of the terminal, a mouse pointer displayed on a screen of the terminal.

2. The method according to claim 1, wherein prior to the detecting an operation of a user on a rear touch panel of a terminal, the method further comprises:
detecting an operation of the user on the terminal;
enabling the rear touch panel of the terminal if the operation of the user on the terminal is consistent with a designated enable operation; and
displaying the mouse pointer on the screen of the terminal.

3. The method according to claim 1, further comprising:
disabling the rear touch panel if it is detected that the user performs no operation on the rear touch panel within a designated period of time; or
detecting an operation of the user on the terminal, and disabling the rear touch panel if it is detected that the operation of the user on the terminal is consistent with a designated disable operation.

4. The method according to claim 1, wherein in the process of controlling the mouse pointer displayed on the screen of the terminal, the position of the mouse pointer on the screen of the terminal corresponds to the position on the finger of the user on the rear touch panel; and/or the operation of the mouse pointer on the screen of the terminal corresponds to the operation of the user on the rear touch panel.

5. The method according to claim 1, wherein
the detecting an operation of a user on a rear touch panel of a terminal comprises: detecting, by a drive corresponding to the rear touch panel in the terminal, the operation of the user on the rear touch panel, and generating operation information; and
the controlling, according to the operation of the user on the rear touch panel of the terminal, a mouse pointer displayed on a screen of the terminal comprises: acquiring, by a hardware abstraction layer in the terminal, an event corresponding to the operation information according to the operation information sent by the drive corresponding to the rear touch panel; and sending, by an framework layer in the terminal, the event acquired by the hardware abstraction layer to an operating system of the terminal, such that the operating system controls, according to the event, the mouse pointer displayed on the screen of the terminal.

6. A terminal, comprising: at least one memory and one or more processors, wherein the one or more processors are configured to execute program instructions stored in the at least one memory to:
detect an operation of a user on a rear touch panel of the terminal; and
control, according to the operation of the user on the rear touch panel of the terminal, a mouse pointer displayed on a screen of the terminal.

7. The terminal according to claim 6, wherein prior to the detecting an operation of a user on a rear touch panel of a terminal, the one or more processors are further configured to execute the program instructions stored in the at least one memory to:
detect an operation of the user on the terminal;
enable the rear touch panel of the terminal if the operation of the user on the terminal is consistent with a designated enable operation; and
display the mouse pointer on the screen of the terminal.

8. The terminal according to claim 6, wherein the one or more processors are further configured to execute the program instructions stored in the at least one memory to: disable the rear touch panel if it is detected that the user performs no operation on the rear touch panel within a designated period of time; or
detect an operation of the user on the terminal, and disable the rear touch panel if it is detected that the operation of the user on the terminal is consistent with a designated disable operation.

9. The terminal according to claim 6, wherein the one or more processors are further configured to execute the program instructions stored in the at least one memory to: in the process of controlling the mouse pointer displayed on the screen of the terminal, cause the position of the mouse pointer on the screen of the terminal to correspond to the position on the finger of the user on the rear touch panel; and/or cause the operation of the mouse pointer on the screen of the terminal to correspond to the operation of the user on the rear touch panel.

10. The terminal according to claim 6, wherein the detecting an operation of a user on a rear touch panel of a terminal comprises: detecting, by a drive corresponding to the rear touch panel in the terminal, the operation of the user on the rear touch panel, and generating operation information; and
the controlling, according to the operation of the user on the rear touch panel of the terminal, a mouse pointer displayed on a screen of the terminal comprises: acquiring, by a hardware abstraction layer in the terminal, an event corresponding to the operation information according to the operation information sent by the drive corresponding to the rear touch panel; and sending, by an framework layer in the terminal, the event acquired by the hardware abstraction layer to an operating system of the terminal, such that the operating system controls, according to the event, the mouse pointer displayed on the screen of the terminal; and
sending, by an framework layer in the terminal, the event acquired by the hardware abstraction layer to an operating system of the terminal, such that the operating system controls, according to the event, the mouse pointer displayed on the screen of the terminal.

11. A non-transitory computer readable storage medium storing computer readable instructions, wherein the computer readable instructions are configured to:
detect an operation of a user on a rear touch panel of a terminal; and
control, according to the operation of the user on the rear touch panel of the terminal, a mouse pointer displayed on a screen of the terminal.

12. The non-transitory computer readable storage medium according to claim 11, wherein prior to the detecting an operation of a user on a rear touch panel of a terminal, the computer readable instructions are further configured to:
detect an operation of the user on the terminal;
enable the rear touch panel of the terminal if the operation of the user on the terminal is consistent with a designated enable operation; and
display the mouse pointer on the screen of the terminal.

13. The non-transitory computer readable storage medium according to claim 11, wherein the computer readable instructions are further configured to:
disable the rear touch panel if it is detected that the user performs no operation on the rear touch panel within a designated period of time; or
detect an operation of the user on the terminal, and disable the rear touch panel if it is detected that the operation of the user on the terminal is consistent with a designated disable operation.

14. The non-transitory computer readable storage medium according to claim 11, wherein the computer readable instructions are further configured to: in the process of controlling the mouse pointer displayed on the screen of the terminal, cause the position of the mouse pointer on the screen of the terminal to correspond to the position on the finger of the user on the rear touch panel; and/or cause the operation of the mouse pointer on the screen of the terminal to correspond to the operation of the user on the rear touch panel.

15. The non-transitory computer readable storage medium according to claim 11, wherein
the detecting an operation of a user on a rear touch panel of a terminal comprises: detecting, by a drive corresponding to the rear touch panel in the terminal, the operation of the user on the rear touch panel, and generating operation information; and
the controlling, according to the operation of the user on the rear touch panel of the terminal, a mouse pointer displayed on a screen of the terminal comprises: acquiring, by a hardware abstraction layer in the terminal, an event corresponding to the operation information according to the operation information sent by the drive corresponding to the rear touch panel; and sending, by an framework layer in the terminal, the event acquired by the hardware abstraction layer to an operating system of the terminal, such that the operating system controls, according to the event, the mouse pointer displayed on the screen of the terminal; and
sending, by an framework layer in the terminal, the event acquired by the hardware abstraction layer to an operating system of the terminal, such that the operating system controls, according to the event, the mouse pointer displayed on the screen of the terminal.
